(19) United States
(12) Patent Application Publication
(10) Pub. No.: US 2013/0289165 A1
(43) Pub. Date: Oct. 31, 2013

(54) COMPOSITION BASED ON NATURAL RUBBER AND CARBON BLACK COMPRISING A HYDRAZIDE, A HYDRAZONE AND A POLYAMINE

(71) Applicants: Stéphanie De Landtsheer, Clermont-Ferrand Cedex 9 (FR); Damien Thomasson, Clermont-Ferrand Cedex 9 (FR)

(72) Inventors: Stéphanie De Landtsheer, Clermont-Ferrand Cedex 9 (FR); Damien Thomasson, Clermont-Ferrand Cedex 9 (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 13/995,692

(22) PCT Filed: Dec. 19, 2011
(86) PCT No.: PCT/EP11/73234

§ 371 Date: Jul. 12, 2013

(30) Foreign Application Priority Data
Dec. 21, 2010 (FR) 1060970

(51) Int. Cl. C08K 5/24; C08K 3/04

(52) U.S. Cl. CPC C08K 5/24; C08K 3/04
USPC 523/351; 524/192

(57) ABSTRACT

Reinforced rubber composition based at least (a) on an elastomeric matrix comprising natural rubber as the predominant diene elastomer, (b) on a reinforcing filler comprising carbon black in a weight fraction of more than 50% relative to the total weight of the filler, and (c) on a compound belonging to the families of hydrazides or hydrazones or to the family of amines, wherein the carbon black is dispersed in the elastomeric matrix with a Z value of greater than or equal to 80. This rubber composition is intended, for example, for the manufacture of a semi-finished rubber product intended for a tyre of motor vehicles.

### BACKGROUND

1. Field

The present invention relates to rubber compositions reinforced by carbon black, the elastomeric matrix of which is based on natural rubber and in which the filler displays a very good level of dispersion. The invention also relates to the preparation of reinforced rubber compositions from a masterbatch based on natural rubber and on carbon black in which the filler has a high level of dispersion. These rubber compositions are intended, for example, for the manufacture of semi-finished rubber products intended for the tyres of motor vehicles.

2. Description of Related Art

A rubber composition reinforced by carbon black or another reinforcing filler and intended for tyre manufacture must have specific mechanical and dynamic properties that allow the tyre to meet a large number of technical requirements.

Since fuel savings and the need to protect the environment have become a priority, it has proved necessary to produce tyres that have a reduced rolling resistance. Lowering the hysteresis of a rubber composition is a descriptor of a lower rolling resistance for the tyres comprising them. In order to achieve the objective of lowering the hysteresis, many solutions have already been tested.

Thus, certain molecules such as hydrazides or hydrazones are, generally, known for lowering the hysteresis of mixtures based on natural or synthetic rubber containing carbon black as the sole reinforcing filler or not the sole reinforcing filler. These molecules, belonging to a family close to that of amines, are compounds comprising at least one amine group and another, amino or non-amino, polar group. Mention may be made of extensive literature dealing with this subject. Thus, to cite but a few thereof, documents EP 0 478 274, JP 5098074, JP 10139934, U.S. Pat. No. 3,660,438 and U.S. Pat. No. 4,077,948 describe the use of hydrazides and hydrazones for gains in the hysteresis of a black-based composition. The Applicant companies also describe, in their applications WO 10/072,762 and WO 10/072,763, improvements in the compromise of properties of reinforced compositions based on natural rubber, with the demonstration of an improvement of the hysteresis also for compositions based on natural rubber and silica as the sole or predominant reinforcing filler.

Other molecules, such as polyamines are, generally, known for lowering the hysteresis of mixtures based on natural or synthetic rubber containing silica as described in document US 2005/0085583 or containing carbon black as described in application PCT/EP10/059,829 by the Applicant companies.

Without being limited to one particular mechanism, it appears that these two families of molecules act in an identical manner. These families encompass bifunctional molecules that react with carbonyl functions. In the presence of natural rubber and carbon black, one of the two functions reacts with a chemical function borne by the natural rubber (including oxidized functions, preferably carbonyl functions) and the other with the polar functions borne by the surface of the carbon black (preferably carbonyl functions).

Reducing the rolling resistance further remains, within the current economic and ecological context, a permanent concern despite the levels already achieved with the various solutions from the prior art.

### SUMMARY

The problem addressed by the present invention is to find a rubber composition having a hysteresis that is lowered further compared to the levels achieved by compositions using, as additives, compounds belonging to the families of hydrazides or hydrazones or to the families of polyamines, so as to make it possible to achieve an even lower rolling resistance of the tyres containing this composition.

This problem is solved in that the addition of certain compounds belonging to the families of hydrazides or hydrazones or to the families of polyamines to rubber compositions reinforced by carbon black that has a high level of dispersion in said composition, makes it possible to significantly reduce the hysteresis of the rubber composition compared to a composition of the same formulation for which the carbon black does not have this level of dispersion.

Such a level of dispersion may especially be obtained by the addition of these compounds belonging to the families of hydrazides or hydrazones or to the families of polyamines to a specific masterbatch based on natural rubber and carbon black. The reinforced rubber compositions resulting from processes incorporating all or some of the filler in the form of masterbatches based on natural rubber and carbon black also makes it possible to significantly reduce the hysteresis of the rubber composition comprising these compounds compared to a composition of the same formulation for which the carbon black and the natural rubber are not introduced in the form of a masterbatch.

Although the compounds belonging to the families of hydrazides or hydrazones or to the families of polyamines are known for improving the hysteresis properties, the reduction in the hysteresis in the proportions observed is at the very least unexpected, especially in view of the teaching of the prior art and general knowledge of those skilled in the art.

Generally, it is known that in order to obtain the optimum reinforcing properties imparted by a filler, it is advisable for this filler to be present in the elastomeric matrix in a final form that is both as finely divided as possible and as uniformly distributed as possible. However, such conditions can be achieved only if the filler has a very good capacity, on the one hand, to be incorporated into the matrix during the mixing with the elastomer and to deagglomerate, and, on the other hand, to disperse uniformly in this matrix. Within the context of the preparation of rubber compositions reinforced with carbon black, the production of specific masterbatches for incorporating the carbon black into the elastomeric matrix makes it possible to achieve optimum dispersion levels and an optimum distribution.

During the addition to the masterbatch, in which a good state of dispersion of the black has been obtained and in which the establishment of the interface and of the elastomer/filler bond is already advanced due in particular to the distribution of the filler dispersed within the elastomeric matrix, it was not obvious whether the molecules of hydrazides, hydrazones or polyamines could still have an effect on the hysteresis.

This interpretation is furthermore confirmed by document JP 8027315, which mentions the competition between the polar groups present at the surface of the black and the polymer which leads to a greater reactivity of the hydrazino radical with the carbon black compared to the polymer. This is why it is advisable to prevent any contact with the filler before the modification of the polymer. This document recommends a process of specific compounding of the polymer and of the hydrazide in a first step, then, in a second step, of compounding the addition of the carbon black in order to prevent this competition.

A first subject of the invention is therefore a reinforced rubber composition based on an elastomeric matrix comprising natural rubber as the predominant diene elastomer, on a reinforcing filler comprising predominantly carbon black and on an addive belonging to the family of hydrazides or hydrazones or to the family of polyamines, in which the filler, including the carbon black, is dispersed in the elastomeric matrix with a Z value of greater than or equal to 85.

Another subject of the invention is a process for preparing a reinforced rubber composition based on an elastomeric matrix comprising natural rubber as the predominant diene elastomer, on a reinforcing filler comprising predominantly carbon black and on an additive belonging to the family of hydrazides or hydrazones or to the family of polyamines, from a specific masterbatch comprising natural rubber and carbon black.

According to a first variant of the process according to the invention, the carbon black is dispersed in the masterbatch with a very good dispersion, denoted by Z, which is greater than or equal to 90.

According to a second variant of the process according to the invention, the carbon black is dispersed in the masterbatch according to a process of liquid-phase compounding starting from at least a natural rubber latex and an aqueous dispersion of carbon black.

According to a third variant, the first two variants are combined.

Another subject of the invention is a masterbatch comprising at least natural rubber, carbon black and a compound belonging to the family of hydrazides or hydrazones or to the family of polyamines. This masterbatch appears as being an intermediate product of variants of the process according to the invention.

Another subject of the invention is a process for lowering the hysteresis of a reinforced rubber composition based on natural rubber as the predominant elastomer, on a reinforcing filler comprising predominantly carbon black and on an additive belonging to the family of hydrazides or hydrazones or to the family of polyamines or on a mixture of these additives. Given its significantly improved hysteresis properties, this rubber composition is particularly suitable for the manufacture of semi-finished rubber products intended for the tyres of motor vehicles.

Another subject of the invention is a semi-finished rubber product for a tyre consisting completely or partly of the reinforced rubber composition defined above.

Another subject of the invention is a tyre comprising at least one semi-finished rubber product consisting completely or partly of the reinforced rubber composition as defined above.

### DETAILED DESCRIPTION OF SPECIFIC EMBODIMENTS

For greater clarity when reading what follows, the expression composition “based on” is understood to mean a composition comprising the mixture and/or the reaction product of the various constituents used, some of these base constituents being capable of reacting, or intended to react, with one another, at least partly, during the various phases of manufacture of the composition, in particular during its crosslinking or vulcanization.

Moreover, any range of values denoted by the expression “between a and b” represents the field of values ranging from more than a to less than b (that is to say limits a and b excluded) whereas any range of values denoted by the expression “from a to b” means the field of values ranging from a up to b (that is to say including the strict limits a and b). In the present description, unless expressly indicated otherwise, all the percentages (%) shown are % by weight.

Furthermore, the amounts of the components of the invention may be expressed in phr, i.e. in parts by weight per hundred parts by weight of elastomer.

The term “masterbatch” is understood to mean an elastomer-based composite into which a filler and optionally other additives have been introduced.

In the present description, the dispersion of filler in an elastomeric matrix is characterized by the Z value, which is measured, after crosslinking, according to the method described by S. Otto et al. in Kautschuk Gummi Kunststoffe, 58th edition, NR 7-8/2005, in agreement with the ISO 11345 standard. This method is described more fully later on in the text.

Thus, a first subject of the invention is a reinforced rubber composition based at least (a) on an elastomeric matrix comprising natural rubber as the predominant diene elastomer, (b) on a reinforcing filler comprising carbon black in a weight fraction of more than 50% relative to the total weight of the filler, and (c) on a compound selected from:
the carbohydrazide of formula H₂N—NH—CO—NH—NH₂ and
the compounds corresponding to one of the following formulae:

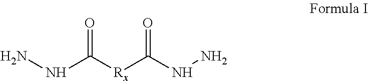

in which:
   R is a divalent hydrocarbon-based radical, which may comprise one or more heteroatoms such as O, N, S or Si, selected from substituted or unsubstituted aromatic radicals having from 6 to 20 carbon atoms, linear or branched, saturated or unsaturated aliphatic radicals having from 1 to 20 carbon atoms, a divalent hydantoin residue; and
   x is equal to 0 or 1,

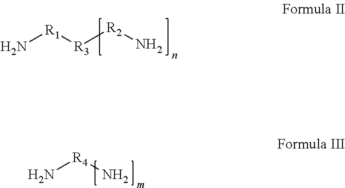

in which:
   R₁ and R₂, which are identical or different, are selected from the group consisting of alkylidenes having from 1 to 20 carbon atoms, cycloalkylidenes having from 5 to 24 carbon atoms, arylidenes having from 6 to 18 carbon atoms, aralkylidenes having from 7 to 25 carbon atoms and heterocycles, which are identical or different, having from 4 to 25 carbon atoms;
   R₃ and R₄, which are identical or different, are selected from the group consisting of alkylidenes having from 1 to 20 carbon atoms, alkylidynes having from 1 to 20 carbon atoms, alkylylidynes having from 1 to 20 carbon atoms, cycloalkylidenes having from 5 to 24 carbon atoms, cycloalkylidynes having from 5 to 24 carbon atoms, cycloalkylylidynes having from 5 to 24 carbon atoms, arylidenes having from 6 to 18 carbon atoms, arylidynes having from 6 to 18 carbon atoms, arylylidynes having from 6 to 18 carbon atoms, aralkylidenes having from 7 to 25 carbon atoms, aralkylidynes having from 6 to 18 carbon atoms, aralkylylidynes having from 6 to 18 carbon atoms, and heterocycles, which are identical or different, having from 4 to 25 carbon atoms;
   R₃ optionally comprises one or more identical or different heteroatom(s), selected from O, N, S and Si;
   m is equal to 1, 2 or 3;
   n is equal to 1, 2 or 3,

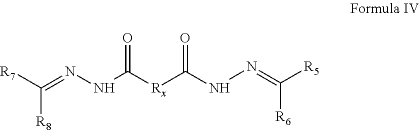

in which:
   R₅, R₆, R₇ and R₈, which are identical or different, are selected from alkyl groups having from 1 to 20 carbon atoms, cycloalkyl groups having from 5 to 24 carbon atoms, aryl groups having from 6 to 18 carbon atoms or aralkyl groups having from 7 to 25 carbon atoms;
   R and x are as defined above for Formula I,

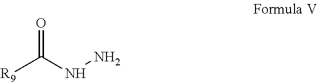

in which:
   R₉ is a polar group which is selected from at least one of alkylene groups, phenylene groups or heterocycles containing nitrogen or oxygen having at least one imino, nitrile, ammonium, imido, amide, hydrazo, azo, diazo, hydroxyl, carboxylic, epoxide, oxycarbonyl, tin or alkoxysilyl group,

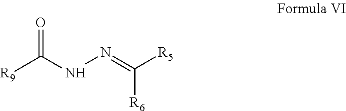

in which:
   R₅, R₆ and R₉ are as defined above for Formulae IV and V.

This composition according to the invention is essentially characterized in that the filler, including the carbon black, is dispersed in the elastomeric matrix of the composition with a Z value of greater than or equal to 85.

According to a second aspect of the invention, the composition is obtained from the masterbatch, characterized in that the carbon black is dispersed in the masterbatch with a dispersion Z value of greater than or equal 90.

There are various methods for obtaining a masterbatch of diene elastomer and reinforcing filler. In particular, one type of solution consists, in order to improve the dispersion of the filler in the elastomeric matrix, in compounding the elastomer and the filler in the “liquid” phase. To do so, the process involves an elastomer in latex form, which is in the form of water-dispersed elastomer particles, and an aqueous dispersion of the filler, that is to say a filler dispersed in water, commonly referred to as a “slurry”.

Thus, according to one of the variants of the invention, the masterbatch is obtained by liquid-phase compounding starting from a diene elastomer latex and an aqueous dispersion of carbon black.

More preferably still, the masterbatch according to the invention is obtained according to the following process steps, enabling a very good dispersion of the filler in the elastomeric matrix to be obtained:
feeding, with a first continuous flow of a diene elastomer latex, a mixing zone of a coagulation reactor defining an elongate coagulation zone extending between the mixing zone and an outlet,
feeding said mixing zone of the coagulation reactor with a second continuous flow of a fluid comprising a filler under pressure in order to form a mixture with the elastomer latex by mixing the first fluid and the second fluid in the mixing zone in a sufficiently energetic manner to coagulate the elastomer latex with the filler before the outlet, said mixture flowing as a continuous flow to the outlet zone and said filler being capable of coagulating the elastomer latex,
recovering, at the outlet of the reactor, the coagulum obtained above in the form of a continuous flow and drying it in order to recover the masterbatch.

This process for preparing a masterbatch in the liquid phase is described in detail in document WO 97/36724 (U.S. Pat. No. 6,048,923). A person skilled in the art will know how to determine the aspects of the process described that apply to the present invention.

The rubber composition according to the invention comprises at least three compounds, including the elastomeric matrix.

According to the invention, the elastomeric matrix of the composition is predominantly based on natural rubber. In certain cases, the elastomeric matrix may advantageously consist entirely of natural rubber (100% of the elastomeric matrix consists of natural rubber).

The natural rubber according to the invention may, according to certain variants, be modified. This modification may take on several aspects. Thus, for example and to cite only these two types of modifications, the natural rubber may be functionalized, it is then preferably an epoxidized natural rubber (ENR), or else the natural rubber may be deproteinized to thereby modify its purity.

The elastomeric matrix may also, besides the natural rubber, comprise at least one other diene elastomer.

This or these other diene elastomer or elastomers are then present in the matrix in proportions of between 0 and 50% by weight (the limits of this range being excluded), preferably from 5% to 40%, more preferably still from 15% to 40%.

In the case of a blend with at least one other diene elastomer, the weight fraction of the natural rubber in the elastomeric matrix is predominant and preferably greater than or equal to 50% by weight of the total weight of the matrix, more preferably still from 60% to 85% by weight of the total weight of the matrix.

The predominant weight fraction according to the invention refers to the highest weight fraction of the blend. Thus, in an NR/elastomer A/elastomer B blend, the weight fractions may be distributed according to 40/40/20 or 40/30/30, the predominant weight fractions being respectively 40. And in an NR/elastomer blend, the weight fractions may be distributed according to 50/50 or 70/30, the predominant weight fractions being respectively 50 or 70.

The term “diene elastomer” should be understood according to the invention as meaning any synthetic elastomer resulting at least in part from diene monomers. More particularly, the term “diene elastomer” is understood to mean any homopolymer obtained by polymerization of a conjugated diene monomer having from 4 to 12 carbon atoms or any copolymer obtained by copolymerization of one or more conjugated dienes with one another or with one or more vinylaromatic compounds having from 8 to 20 carbon atoms. In the case of copolymers, the latter comprise from 20% to 99% by weight of diene units and from 1% to 80% by weight of vinylaromatic units.

The diene elastomer constituting a portion of the elastomeric matrix according to the invention is preferably selected from the group of highly unsaturated diene elastomers consisting of polybutadienes (BRs), butadiene copolymers, polyisoprenes (PIs), isoprene copolymers and blends of these elastomers. Such copolymers are more preferably selected from the group consisting of copolymers of butadiene and of a vinylaromatic monomer, more particularly the butadiene/styrene copolymer (SBR), isoprene/butadiene copolymers (BIRs), copolymers of isoprene and of a vinylaromatic monomer, more particularly the isoprene/styrene copolymer (SIR), and isoprene/butadiene/styrene copolymers (SBIRs). Particular preference is given, among these copolymers, to copolymers of butadiene and of a vinylaromatic monomer, more particularly the butadiene/styrene copolymer (SBR).

These elastomers may have any microstructure, which depends on the polymerization conditions used, in particular on the presence or absence of a modifying and/or randomizing agent, and on the amounts of modifying and/or randomizing agent employed. The elastomers may, for example, be block, statistical, sequential or microsequential elastomers and may be prepared in dispersion or in solution.

The diene elastomer constituting a portion of the elastomeric matrix according to the invention may or may not be star-branched, coupled or functionalized, in a manner known per se, by means of functionalization, coupling or star-branching agents known to a person skilled in the art.

As was specified above, liquid-phase compounding processes are preferably used to make it possible to obtain masterbatches based on diene elastomer and on carbon black that have a very good dispersion of the carbon black in the elastomer. Thus, in particular, use will more particularly be made of a diene elastomer latex, the elastomer latex being a particular form of the elastomer that is in the form of water-dispersed elastomer particles.

Regarding the predominant elastomer according to the invention, the latex of natural rubber (NR) exists in various forms as explained in detail in Chapter 3 “Latex concentrates: properties and composition” by K. F. Gaseley, A. D. T. Gordon and T. D. Pendle in “Natural Rubber Science and Technology”, A. D. Roberts, Oxford University Press—1988.

In particular, several forms of natural rubber latex are sold: the natural rubber latices referred to as “field latices”, the natural rubber latices referred to as “concentrated natural rubber latices”, epoxidized latices (ENR), deproteinized latices or else prevulcanized latices. The natural rubber field latex is a latex to which ammonia has been added to prevent premature coagulation and the concentrated natural rubber latex corresponds to a field latex that has undergone a treatment corresponding to a washing followed by a further concentration. The various categories of concentrated natural rubber latices are listed in particular according to the ASTM D 1076-06 standard. Distinguished in particular from among these concentrated natural rubber latices are the concentrated natural rubber latices of “HA” (high ammonia) quality and of “LA” (low ammonia) quality; for the invention, use will advantageously be made of concentrated natural rubber latices of HA quality.

The natural rubber latex may be physically or chemically modified beforehand (centrifugation, enzyme treatment, chemical modifier, etc.).

The latex may be used directly or may be first diluted in water to facilitate the processing thereof.

According to the invention, the natural rubber can be used as a blend with at least one other diene elastomer. When this is the case, and according to one aspect of the invention, all or some of this diene elastomer may be incorporated during the processes of liquid-phase compounding in latex form in order to obtain masterbatches.

As synthetic diene elastomer latex, the latex may in particular consist of a synthetic diene elastomer already available in the form of an emulsion, or of a synthetic diene elastomer initially in solution, which is emulsified in a mixture of organic solvent and water, generally by means of a surfactant.

It will be noted that it is possible to envisage using one or more natural rubber latices as a blend, or a blend of one or more natural rubber latices with one or more synthetic rubber latices.

It should be noted that all or some of the elastomeric matrix and more particularly all or some of the natural rubber may be incorporated in the form of a masterbatch in order to form the rubber composition according to the invention. Thus, by way of example, all of the natural rubber is incorporated in the form of a masterbatch in order to form the rubber composition according to the invention

The rubber composition according to the invention also comprises a reinforcing filler comprising carbon black in a weight fraction of more than 50% relative to the total weight of the filler.

All carbon blacks, in particular blacks of the HAF, ISAF or SAF type, conventionally used in tyres (“tyre-grade” blacks) are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or else, depending on the applications targeted, the blacks of higher series (for example, N400, N660, N683, N772 or N990). A mixture of various carbon blacks can also be envisaged within the context of the invention.

Also suitable as carbon black are the carbon blacks partially or completely covered with silica via a post-treatment, or the carbon blacks modified in situ by silica such as, non-limitingly, the fillers sold by Cabot Corporation under the name Ecoblack™ “CRX 2000” or “CRX 4000”.

All or some of the carbon black may be incorporated into the elastomer to form the masterbatch. The amount of carbon black in the masterbatch is at least 30%, preferably at least 40%, or even at least 45%, and this amount is at most 80%, preferably at most 70%, or even at most 65%, by weight relative to the weight of the elastomer contained in the masterbatch.

According to the invention, the filler in the composition predominantly consists of carbon black, that is to say that the proportion of carbon black is greater than or equal to 50% by weight of the of the total weight of the filler, more particularly greater than 50%. Preferably, the filler consists of from 55% to 100% by weight of carbon black.

When the filler also comprises another filler, it may be inorganic or organic, identical to or different from that included in the masterbatch. In this case, the proportion of this filler is greater than 0% by weight and less than 50%, preferably at most 45%, by weight relative to the total weight of the filler.

Mention may be made, as examples of organic fillers other than carbon blacks, of functionalized polyvinylaromatic organic fillers, as described in applications WO-A-2006/069792 and WO-A-2006/069793, or else of functionalized nonaromatic polyvinyl organic fillers, as described in applications WO-A-2008/003434 and WO-A-2008/003435.

The expression “inorganic filler” should be understood in the present application, by definition, to mean any inorganic or mineral filler, whatever its colour and its origin (natural or synthetic), also referred to as “white filler”, “clear filler” or even “non-black filler”, in contrast to carbon black, this inorganic filler being capable of reinforcing by itself alone, without means other than an intermediate coupling agent, a rubber composition intended for the manufacture of tyres, in other words capable of replacing, in its reinforcing role, a conventional tyre-grade carbon black. Such a filler is generally characterized, in a known manner, by the presence of hydroxyl (—OH) groups, at its surface, requiring, in order to be used as a reinforcing filler, the use of a coupling agent or system intended to provide a stable chemical bond between the diene elastomer and said filler.

Such an inorganic filler may therefore be used with a coupling agent in order to enable the reinforcement of the rubber composition in which it is included. It may also be used with a covering agent (which does not provide a bond between the filler and the elastomeric matrix) in addition to a coupling agent or not (in this case the inorganic filler does not play a reinforcing role).

Mineral fillers of the siliceous type, in particular silica (SiO₂), or of the aluminous type, in particular alumina (Al₂O₃), are suitable in particular as inorganic fillers. The silica used may be any silica known to those skilled in the art.

Preferably, the inorganic fillers for which the mean size (by weight) is between 20 and 300 nm, more preferably between 20 and 150 nm, are particularly suitable. This mean size is conventionally measured after dispersion, by ultrasonic deagglomeration, of the filler to be analysed in water or an aqueous solution containing a surfactant. For an inorganic filler such as silica, the measurement is carried out using an X-ray detection centrifugal sedimentometer of “XDC” (X-ray disc centrifuge) type, sold by Brookhaven Instruments, according to the particular procedure that consists in producing a suspension of a 3.2 g sample of inorganic filler to be analysed in 40 ml of water by the action, over 8 minutes, at 60% power (60% of the maximum position of the “output control”), of a 1500 W ultrasonic probe (¾ inch Vibracell sonicator sold by Bioblock); after sonication, 15 ml of the suspension are introduced into the disc rotating at a speed that varies between 3000 and 6000 rpm (the speed being adapted as a function of the mean size of the filler: the smaller the size, the higher the speed); after sedimentation for 120 minutes, the weight distribution of the particle sizes and the mean size, by weight, of the particles dw are calculated by the software of the “XDC” sedimentometer (dw=Σ(ni di5)/Σ(ni di4) with ni being the number of objects of the size class or diameter di).

The physical state in which the reinforcing inorganic filler is present is not important, whether it is in the form of a powder, of microbeads, of granules or of beads. Of course, the expression “reinforcing inorganic filler” is also understood to mean mixtures of various reinforcing inorganic fillers, in particular of highly dispersible silicas as described above. A person skilled in the art will understand that a reinforcing filler of another nature, in particular organic nature, might be used as filler equivalent to the inorganic filler described in the present section, provided that this reinforcing filler is covered with an inorganic layer, such as silica, or else comprises, at its surface, polar functional sites.

Preferably, the content of total filler (carbon black and inorganic filler such as silica) is between 20 and 200 phr, more preferably between 30 and 150 phr and more preferably still between 30 and 100 phr, the optimum being, in a known manner, different depending on the particular applications.

The rubber composition according to the invention comprises at least three components, including the compound (c) selected from the carbohydrazide of formula H₂N—NH—CO—NH—NH₂ and the compounds corresponding to formulae I, II, III, IV, V and VI as described above. The hydrazides belong to a family similar to that of amines. This is the reason why these compounds encompass both the dihydrazides of formula I and monohydrazides of formula V and the polyamines of formulae II and III, and also their dihydrazones of formula IV or monohydrazone VI protected forms.

According to the present invention, the dihydrazide compounds corresponding to formula I are preferably selected from those for which, in formula I, R is a divalent hydrocarbon-based radical selected from unsubstituted aromatic radicals having from 6 to 14 carbon atoms and linear saturated aliphatic radicals having from 3 to 12 carbon atoms.

More preferably, these dihydrazide compounds are selected from phthalic dihydrazide, isophthalic dihydrazide, terephthalic dihydrazide, succinic dihydrazide, adipic dihydrazide, azelaic dihydrazide, sebacic dihydride, oxalic dihydrazide and dodecanoic dihydrazide.

According to the present invention, the polyamine compounds corresponding to formula II or III are preferably selected from those for which R₁, R₂ and R₄ are each a hydrocarbon-based radical selected from unsubstituted, linear or branched, alkylidene radicals having from 2 to 8 carbon atoms and cycloalkylidene radicals having 6 carbon atoms and R₃ is an unsubstituted alkylidene radical having from 2 to 8 carbon atoms or an alkylidene radical having from 2 to 6 carbon atoms comprising N as a heteroatom.

According to the present invention, the polyamine compounds of formula II are preferably selected from 1,2-propylenediamine, 3,3′-dimethyl-4,4′-diaminodicyclohexylmethane, 4,4′-diaminodicyclohexylmethane, isophore diamine, neopentanediamine (2,2-dimethyl-propane-1,3-diamine), 1,8-octamethylenediamine, molten 4,4′-methylenedianiline, ethylenediamine, 1,3-diaminopropane, 1,6-hexamethylenediamine, 1,4-phenylenediamine, 1,3-phenylenediamine, 1,2-phenylenediamine, 1,2-diaminocyclohexane, 1,3-diaminocyclohexane, 1,4-diaminocyclohexane, 1,3-diamino-4-methylbenzene and preferably 1,8-octamethylenediamine, 1,6-hexamethylenediamine, 1,2-diaminocyclohexane and 1,4-diaminocyclohexane.

According to the present invention, the polyamine compounds of formula II are preferably selected from 4,7,10-trioxamidecane-1,13-diamine, 4,9-dioxadodecane-1,12-diamine, diethylenetriamine, N-3-amine-(3-(2-aminoethylamino)propylamine), dipropylene triamine, N,N-bis(3-aminopropyl)methylamine, N-4-amine-(N,N′-bis(3-aminopropyl)-ethylenediamine), 2,4-diamino-6-methyl-1,3,5-triazine, 2,4-diamino-6-phenyl-s-triazine, melamine, triethylenetetramine, tetraethylenepentamine, 2,2′,2″-nitrilotriethylamine, 3,6-dioxaoctane-1,8-diamine, N,N,N-tris(2-aminoethyl)amine, bis(3-aminopropyl)tetramethyl-disiloxane, 2-(2-aminoethoxy)ethanamine, 3-{2-[2-(3-aminopropoxy)ethoxy]ethoxy}-propan-1-amine, 3-[4-(3-aminopropoxy)phenoxy]propan-1-amine, 3-{2-(3-amino-propoxy)-1-[(3-aminopropoxy)methyl]ethoxy}propan-1-amine, 2-({2-[(2-aminophenyl)-thio]ethyl}thio)aniline, 2-[(3-{[(2-aminophenyl)thio]methyl}-2,4,6-trimethylbenzyl)thio]-aniline, 2-({4-[(2-aminophenyl)thio]but-2-enyl}thio)aniline and preferably N,N-bis(2-aminoethyl)ethane-1,2-diamine.

More preferably, the polyamine compounds are selected from the following primary amines: 1,4-diaminocyclohexane, 1,2-diaminocyclohexane, N,N-bis(2-aminoethyl)ethane-1,2-diamine, 1,8-octamethylenediamine and 1,6-hexamethylenediamine.

The hydrazone compounds of formula IV or VI may for example, as is known per se, be synthesized by condensing respectively a hydrazide of formula I or V with a ketone.

According to the present invention, the ketones used for the synthesis of the products claimed in formula IV or VI may be for example:

pentan-3-one, 2,2,6,6-tetramethylcyclohexanone, 2,2,4,4-tetramethyl-3-pentanone, 4-methylpentan-2-one, 2,4-dimethylpentan-3-one, 2,6-dimethylheptan-4-one, cyclohexanone, acetone, 2,6-dimethylcyclohexanone, 2,2,4,4-tetramethylpentan-3-one, (1,1′,3′,1″)ter(cyclohexan)-2′-one, dicyclohexylmethanone, dicyclopentylmethanone, cyclopentanone, bicyclo[3.3.1]nonan-9-one, dicyclopropylmethanone, 2,6-di-tert-butyl-cyclohexanone, 2,6-dimethylcyclohexanone, 2,4-dimethyl-3-pentanone and preferably 4-methylpentan-2-one, 2,4-dimethylpentan-3-one, 2,6-dimethylheptan-4-one, cyclohexanone and cyclopentanone.

According to the present invention, the monohydrazide compounds of formula V are preferably selected from:

2-aminoacetohydrazide, 3-aminopropanoic acid hydrazide, 4-aminobutanoic acid hydrazide, 2-aminobenzohydrazide, 4-aminobenzohydrazide, 2-(methylamino)acetohydrazide, 2-(ethylamino)acetohydrazide, 3-(methylamino)propanoic acid hydrazide, 3-(ethylamino)propanoic acid hydrazide, 3-(propylamino)propanoic acid hydrazide, 3-(isopropylamino)propanoic acid hydrazide, 4-(methylamino)butanoic acid hydrazide, 4-(ethylamino)butanoic acid hydrazide, 4-(propylamino)butanoic acid hydrazide, 4-(isopropylamino)butanoic acid hydrazide, 2-(methylamino)benzohydrazide, 2-(ethyl-amino)benzohydrazide, 2-(propylamino)benzohydrazide, 2-(isopropylamino)benzohydrazide, 4-(methylamino)benzohydrazide, 4 one (ethylamino)benzohydrazide, 4-(propylamino)benzohydrazide, 4-(isopropylamino)benzohydrazide, 2-(dimethylamino)acetohydrazide, 2-(diethylamino)acetohydrazide, 3-(dimethylamino)propanoic acid hydrazide, 3-(diethylamino)propanoic acid, 3-(dipropylamino)propanoic acid hydrazide, 4-(dimethylamino)butanoic acid hydrazide, 4-(diethylamino)butanoic acid hydrazide, 4-(dipropylamino)butanoic acid hydrazide, 4-(diisopropylamino group) butanoic acid hydrazide, 2-(dimethylamino)benzohydrazide, 2-(diethylamino)benzohydrazide, 2-(dipropylamino)benzohydrazide, 2-(diisopropylamino group)benzohydrazide, (diethylamino)benzohydrazide, 4-(dipropylamino)benzohydrazide, 4-(diisopropylamino group)-benzohydrazide, 2-nitroacetohydrazide, 3-nitropropanoic acid hydrazide, 4-nitrobutanoic acid hydrazide, 2-nitrobenzohydrazide, 4-nitrobenzohydrazide, 2-hydroxyacetohydrazide, ethyl 3-hydroxypropanoate on acid hydrazide, 4-hydroxypropanoic acid hydrazide, 2-hydroxybenzohydrazide, 4-hydroxybenzohydrazide, 3-carboxypropanoic acid hydrazide, 4-carboxybutanoic acid hydrazide, 2-benzoic acid hydrazide, 4-benzoic acid hydrazide, (oxiran-2-yl)acetohydrazide, 3-(oxiran-2-yl)propanoic acid hydrazide, 3-(tetrahydro-2H-pyran-4-yl)propanoic acid hydrazide, 3-(tributyltin)propanoic acid hydrazide, 3-(trimethyltin)propanoic acid hydrazide, 3-(triphenyltin)propanoic acid hydrazide, 3-(trioctyltin)-propanoic acid hydrazide, 4-(tributyltin)butanoic acid hydrazide, 4-(trimethyltin)butanoic acid hydrazide, 4-(triphenyltin)butanoic acid hydrazide, 4-(trioctyltin)butanoic acid hydrazide, 2-(tributyltin)benzohydrazide, 4-(tributyltin)benzohydrazide, 2-(trimethyltin)-benzohydrazide, 4-(trimethyltin)benzohydrazide, 2-(trioctyltin)benzohydrazide, 4-(trioctyltin)benzohydrazide, (trimethoxysilyl)acetohydrazide, 2-(triethoxysilyl)acetohydrazide, 3-(trimethoxysilyl)propanoic acid hydrazide, 3-(triethoxysilyl)propanoic acid hydrazide, 4-(trimethoxysilyl)butanoic acid hydrazide, 4-(triethoxysilyl)butanoic acid hydrazide, 2-(trimethoxysilyl)benzohydrazide, 2-(triethoxysilyl)benzohydrazide, 4-(trimethoxysilyl)-benzohydrazide and 4-(triethoxysilyl)benzohydrazide.

The rubber composition of the tyre component according to the invention comprises the compound (c) in an amount of at least 0.1 phr, preferably of at least 0.25 phr, or even of at least 0.5 phr and of at most 7 phr, preferably of at most 5 phr, or even of at most 3 phr. The expression “compound (c)” according to the invention should be understood to mean a compound or a mixture of several compounds (c).

According to one particular embodiment of the invention, the reinforcing filler consists of 100% carbon black. Indeed, it is then possible to obtain the optimum reinforcing and hysteresis properties for the rubber composition used in a tyre tread and also a high wear resistance and a low rolling resistance of the tyre. It is observed that the effect of the compound (c) is retained, or even improved, which is surprising in view of the mechanism of action of these compounds and the general knowledge of those skilled in the art, since in the masterbatch-based compositions, the interface between the filler and the elastomer is already made and since this should be detrimental to the effect of the compound (c). The hysteresis of the rubber composition in accordance with the invention is reduced without adversely affecting the reinforcement and therefore the wear resistance of a tyre comprising this composition.

According to another particular embodiment of the invention, the reinforcing filler comprises, besides the carbon black, a minor fraction of an inorganic filler. That is to say that the weight fraction of the inorganic filler is less than 50% by weight relative to the total weight of the reinforcing filler and greater than 0%, preferably at least 5% by weight. According to this embodiment, the compound (c) does not encompass the dihydrazones of formula IV or monohydrazone VI protected forms. The compound (c) is then selected solely from the carbohydrazide of formula H₂N—NH—CO—NH—NH₂ and the compounds corresponding to formulae I, II, III and V. The rubber composition then has a significant gain in hysteresis much higher than that which would have been able to be achieved. It is observed that the effects of the inorganic filler, in this case silica, and of the compound (c) are retained, or even improved, which is surprising in view of the mechanism of action of these compounds and the general knowledge of those skilled in the art, since in the masterbatch-based compositions, the interface between the filler and the elastomer is already made and since this should be detrimental to the effect of the compound (c).

The rubber composition according to the invention also conventionally comprises, when the filler comprises an inorganic filler, a reinforcing inorganic filler/elastomeric matrix bonding agent and/or a covering agent.

Use is made, in a known manner, in order to couple the reinforcing inorganic filler to the diene elastomer, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

Suitable in particular, without the definition below being limiting, are bonding agents that are at least bifunctional, having for example the simplified general formula “Y-T—X′”, in which:
Y represents a functional group (“Y” function) which is capable of being bonded physically and/or chemically to the inorganic filler, it being possible for such a bond to be established, for example, between a silicon atom of the coupling agent and the surface hydroxyl (—OH) groups of the inorganic filler (for example the surface silanols, when silica is concerned);
X′ represents a functional group (“X′” function) capable of being bonded physically and/or chemically to the elastomer, for example via a sulphur atom;
T represents a divalent group which makes it possible to connect Y and X′.

Use may be made of any bonding agent known for or capable of efficiently providing, in the rubber compositions that can be used for the manufacture of tyres, the bonding (or the coupling) between a reinforcing inorganic filler such as silica, and a diene elastomer, such as, for example, organosilanes, in particular alkoxysilane polysulphides or mercaptosilanes, or else polyorganosiloxanes bearing the abovementioned X′ and Y functions. Silica/elastomer bonding agents, in particular, have been described in a large number of documents, the most well known being bifunctional alkoxysilanes, such as alkoxysilane polysulphides.

In the compositions in accordance with the invention, the content of coupling agent is preferably between 0.3 and 12 phr, more preferably, depending on the applications, between 0.5 and 3 phr or between 3 and 8 phr. But it is generally desirable to use as little as possible thereof. Relative to the weight of reinforcing inorganic filler, the content of coupling agent typically represents at least 0.1% and at most 12%, preferably between 4% and 10% by weight relative to the amount of inorganic filler. The content of coupling agent is also strongly linked to the specific surface area of the filler. This content is easily adjusted by a person skilled in the art according to the content of inorganic filler used in the composition and the specific surface area of the filler.

As covering agent, processing aids will generally be considered that are capable, in a known manner, owing to an improvement in the dispersion of the inorganic filler in the rubber matrix and a lowering of the viscosity of the compositions, of improving their processability in the uncured state, these processing aids being for example hydrolysable silanes, such as alkylalkoxysilanes, polyols, polyethers, primary, secondary or tertiary amines, hydroxylated or hydrolysable POSs, and fatty acids.

In the rubber compositions in accordance with the invention, the content of covering agent is preferably between 0.1% and 20%, more preferably between 5% and 20% by weight relative to the amount of inorganic filler. The content of covering agent is also strongly linked to the specific surface area of the filler. This content is easily adjusted by a person skilled in the art according to the content of inorganic filler used in the composition and the specific surface area of the filler.

The rubber compositions in accordance with the invention may also contain, in addition to coupling and/or covering agents, coupling activators.

The rubber compositions in accordance with the invention may also comprise all or some of the usual additives customarily used in elastomer compositions intended for the manufacture of tyres, such as, for example, pigments, protective agents, such as antiozone waxes, chemical antiozonants, antioxidants, antifatigue agents, reinforcing or plasticizing resins, methylene acceptors (for example, phenol-novolac resin) or methylene donors (for example, HMT or H3M), as described, for example, in application WO 02/10269, a crosslinking system based either on sulphur or on sulphur donors and/or on peroxide and/or on bismaleimides, vulcanization accelerators, vulcanization activators, adhesion promoters, such as cobalt-based compounds, plasticizing agents, preferably nonaromatic or very slightly aromatic plasticizing agents selected from the group consisting of naphthenic oils, paraffinic oils, MES oils or TDAE oils, ether plasticizers, ester plasticizers (for example, glycerol trioleates), and hydrocarbon-based resins having a high Tg, preferably of greater than 30° C., and mixtures of such compounds.

The invention also relates to a process for preparing a reinforced rubber composition based on an elastomeric matrix comprising natural rubber as the predominant diene elastomer, a reinforcing filler comprising predominantly carbon black and an additive belonging to the family of hydrazides or hydrazones or to the family of polyamines, from a specific masterbatch comprising natural rubber and carbon black. The composition thus prepared has a reduced hysteresis level.

According to a first variant of the process according to the invention, the carbon black is dispersed in the masterbatch with a very good dispersion, denoted by Z, which is greater than or equal to 90.

According to a second variant of the process according to the invention, the carbon black is dispersed in the masterbatch according to a process of liquid-phase compounding starting from at least a natural rubber latex and an aqueous dispersion of carbon black.

It should be noted that, according to these variants of the invention, the carbon black is incorporated into the elastomeric matrix in the form of a masterbatch, which may be prepared according to the process steps described above. These steps are then part of the process for preparing the composition according to the invention.

It should also be noted that, according to these variants of the process according to the invention, all or some of the elastomeric matrix comprising the natural rubber or all or some of the filler comprising the carbon black may be incorporated into the rubber composition in the form of a masterbatch.

According to the invention, the compound selected from the carbohydrazide or the compounds corresponding to formulae I, II, III, IV, V and VI, is incorporated at any moment into the process for preparing the rubber composition.

The composition is manufactured in appropriate mixers, using two successive preparation phases well known to those skilled in the art: a first phase of thermomechanical working or kneading (referred to as a “non-productive” phase) at high temperature, up to a maximum temperature of between 110° C. and 190° C., preferably between 130° C. and 180° C., followed by a second phase of mechanical working (referred to as a “productive” phase) at a lower temperature, typically below 110° C., for example between 40° C. and 100° C., during which finishing phase the crosslinking system is incorporated.

The process in accordance with the invention for preparing a rubber composition according to the invention comprises at least the following steps:
(i) carrying out, at a maximum temperature of between 130° C. and 200° C., preferably between 145° C. and 185° C., a first step of thermomechanical working (sometimes described as a “non-productive” phase) of the necessary base constituents of the rubber composition, such as, where appropriate, the remainder of the filler and/or elastomer, with the exception of the crosslinking system, by intimately incorporating ingredients into the elastomeric matrix/carbon black masterbatch, by kneading in one or more stages, then
(ii) carrying out, at a temperature below said maximum temperature of said first step, preferably below 120° C., a second step of mechanical working during which said crosslinking system, and where appropriate an adhesion promoter, are incorporated.

The process according to the invention comprises, where appropriate, prior to carrying out the aforementioned non-productive phase, the stages of the manufacture of the masterbatch based on natural rubber and carbon black according to the various variants mentioned above.

The final composition thus obtained can then be calendered, for example in the form of a sheet or slab, or else extruded, for example to form a rubber profiled element that can be used as a semi-finished rubber product intended for a tyre.

The compound (c) selected from the carbohydrazide and the compounds corresponding to one of the formulae I, II, III, IV, V and VI described above can therefore be incorporated as an ingredient of the rubber composition according to the invention:
during the prior production of a second masterbatch by incorporation into the masterbatch based on natural rubber and carbon black on an open device of open mill type or on a closed device of internal mixer type,
directly into the mixer during the first non-productive phase with the other compounds of the rubber composition,
directly into the mixer during the second phase with the vulcanization system.

Thus, according to a variant, the process according to the invention comprises, prior to carrying out the aforementioned non-productive phase and after manufacture of the masterbatch based on natural rubber and carbon black, a stage of preparing a second masterbatch based on the first masterbatch and on compound (c). This stage may be carried out directly in the “internal” mixer intended for the non-productive phase, just before the incorporation of the other ingredients of the composition, with the exception of the crosslinking system.

According to another variant of the process of the invention, all the base constituents of the composition of the invention, including the compound (c) but with the exception of the vulcanization system, are incorporated into the elastomeric matrix/carbon black masterbatch during the first stage, referred to as the aforementioned non-productive phase. This variant is particularly preferred over the preceding one since it enables the process for preparing the rubber composition to be simplified.

According to another variant of the process of the invention, the compound (c) is incorporated into the mixture during the second step of mechanical working during which the crosslinking system, and where appropriate an adhesion promoter, are incorporated.

Another subject of the invention is the combinations of these variants which means that the compound (c) may be incorporated in several instalments during the various stages of the process.

Another subject of the invention is a finished or semi-finished rubber product, comprising a reinforced rubber composition according to the invention, more particularly a finished or semi-finished rubber product for a tyre.

Due to the reduced hysteresis which characterizes a reinforced rubber composition according to the invention, it will specifically be noted that an application in a tyre is particularly advantageous. More particularly, a tread comprising the composition gives the tyre that comprises it an advantageously reduced rolling resistance and self-heating.

Another subject of the invention is a tyre that incorporates, in at least one of its constituent elements, a reinforced rubber composition according to the invention.

The aforementioned features of the present invention, and others, will be better understood on reading the following description of several exemplary embodiments of the invention, given by way of illustration and without implied limitation.

### I. Measurements and Tests Used

The rubber compositions are characterized before and after curing, as indicated below.

### Mooney Plasticity

Use is made of an oscillating consistometer as described in the French standard NF T 43-005 (1991). The Mooney plasticity measurement is carried out according to the following principle: the composition in the uncured state (i.e. before curing) is moulded in a cylindrical chamber heated to 100° C. After preheating for one minute, the (small-sized) rotor rotates within the test specimen at 2 rpm and the working torque for maintaining this movement is measured after rotating for 4 minutes. The Mooney plasticity (MS 1+4) is expressed in “Mooney units” (MU, with 1 MU=0.83 Newton·metre).

### Dispersion

As is known, the dispersion of filler in an elastomeric matrix can be represented by the Z value, which is measured, after crosslinking, according to the method described by S. Otto et al. in Kautschuk Gummi Kunststoffe, 58th edition, NR 7-8/2005, in agreement with the standard ISO 11345.

The calculation of the Z value is based on the percentage of surface area in which the filler is not dispersed (“% undispersed surface area”), as measured by the “disperGRADER+” machine provided with its operating process and its “disperDATA” operating software by Dynisco, according to the equation:

Z=100−(% undispersed surface area)/0.35

The percentage of undispersed surface area is, itself, measured by a camera that observes the surface area of the sample under incident light at 30°. The light points are associated with the filler and agglomerates, whilst the dark points are associated with the rubber matrix; digital processing converts the image into a black and white image, and enables the determination of the percentage of undispersed surface area, as described by S. Otto in the aforementioned document.

The higher the Z value, the better the dispersion of the filler in the rubber matrix (a Z value of 100 corresponding to a perfect dispersion and a Z value of 0 to a mediocre dispersion).

A Z value greater than or equal to 80 will be considered to correspond to a surface area having a very good dispersion of the filler in the elastomeric matrix.

### Tensile Tests

These tensile tests make it possible to determine the elasticity stresses and the properties at break. Unless otherwise indicated, they are carried out in accordance with the French Standard NF T 46-002 of September 1988. At second elongation (i.e. after an accommodation cycle at the extension rate provided for the measurement itself) the nominal secant modulus (or apparent stress, in MPa) is measured at 100% elongation (denoted by MA100) or at 300% elongation (denoted by MA300). The MA300/MA100 ratio makes it possible to identify the level of reinforcement of the composition. The tensile measurements for determining the secant accommodated moduli are carried out at a temperature of 23° C.±2° C. and under standard hygrometry conditions (50%±5% relative humidity).

The stresses at break (in MPa) and elongations at break (in %) are also measured. The tensile measurements for determining the properties at break are carried out at a temperature of 60° C.±2° C., and under standard hygrometry conditions (50%±5% relative humidity), according to the French standard NF T 40-101 (December 1979).

### Dynamic Properties

The dynamic properties and in particular tan(δ)max, representative of the hysteresis, are measured on a viscosity analyser (Metravib VA4000), according to the standard ASTM D 5992-96. The response of a sample of vulcanized composition (cylindrical test specimen with a thickness of 4 mm and with a cross section of 400 mm²), subjected to a simple alternating sinusoidal shear stress, at a frequency of 10 Hz, is recorded under standard temperature conditions (23° C.) according to the standard ASTM D 1349-99, or, depending on the case, at a different temperature; in particular in the examples cited, the measurement temperature is 60° C. A peak-to-peak strain amplitude sweep is carried out from 0.1% to 50% (forward cycle) and then from 50% to 0.1% (return cycle). The result made use of is the loss factor tan(δ). For the return cycle, the maximum value of tan(δ) observed, denoted by tan(δ)max, is indicated. A reduction in the value of tan(δ)max, and therefore in the hysteresis of the composition, is a recognised indicator of reduced rolling resistance and reduced self-heating.

### II. Preparation of the Masterbatches

The first diene elastomer and carbon black masterbatches having a dispersion value of the filler in the elastomeric matrix of greater than or equal to 90 are produced in the liquid phase according to the process described in the U.S. Pat. No. 6,048,923 (WO 97/36724).

Thus, a masterbatch is prepared, according to the protocol explained in detail in the aforementioned patent, from carbon black N234 sold by Cabot Corporation, and natural rubber field latex originating from Malaysia and having a rubber solids content of 28% and an ammonia content of 0.3%.

The masterbatch obtained is a masterbatch of natural rubber and carbon black N234 in which the content of carbon black is 57 phr and which has a dispersion of the black in the natural rubber matrix that has a Z value of 91.

### III. Preparation of the Rubber Compositions

Two molecules of dihydrazide type (corresponding to formula I described above) were used as additives of (natural rubber/carbon black) masterbatches for preparing compositions in accordance with the preferred variant of the process of the invention:
terephthalic dihydrazide,
adipic dihydrazide.

The two molecules are represented in the figures below.

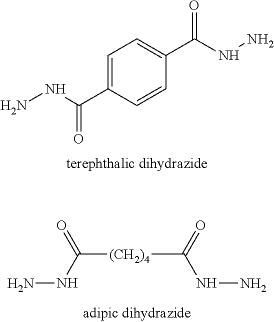

### 1. Control Compositions:

The control compositions T are produced according to a conventional process of compounding in solid form in which the natural rubber, referenced TSR20, and the carbon black N234 sold by Cabot Corporation are introduced in solid form.

The dihydrazide is incorporated beforehand into the natural rubber in order to manufacture a natural rubber/dihydrazide masterbatch in the following manner:

On an open mill, the rolls of which have a diameter equal to 150 mm, a nip equal to 2 mm and a rotational speed of the rolls of 20 rpm, the natural rubber is subjected to the following stages:
1) 3 passes of the natural rubber initially at ambient temperature;
2) addition of a given amount of dihydrazide in powder form;
3) carrying out 12 passes so as to disperse the powder and to homogenize the sample.

Each of the compositions is produced, in a first step, by thermomechanical working and then, in a second finishing step, by mechanical working.

Introduced into an internal mixer, the capacity of which is 3.3 l, filled to 70%, and the initial vessel temperature of which is around 60° C., are this natural rubber/dihydrazide masterbatch and the reinforcing filler (here N234) during the first minute of kneading. After one to two minutes of kneading, the stearic acid, the antioxidant and the paraffin are introduced. The zinc oxide is introduced at 145° C. Thermomechanical working (non-productive phase) is then carried out in one stage (total duration of the kneading equal to around 5 min), until a maximum “dropping” temperature of around 165° C. is reached.

The aforementioned first step of thermomechanical working is thus carried out, it being specified that the mean speed of the blades during this first step is 40 rpm.

The mixture thus obtained is recovered and cooled and then, in an external mixer, the sulphur and the sulphenamide are added at 30° C., the combined mixture being further mixed for a time of 3 to 4 minutes (second aforementioned step of mechanical working).

The compositions thus obtained are subsequently calendered, either in the form of slabs (with a thickness ranging from 2 to 3 mm) or thin sheets of rubber, for the measurement of their physical or mechanical properties.

2. Compositions in Accordance with the Invention

Each of the compositions is produced, in a first step, by thermomechanical working and then, in a second finishing step, by mechanical working.

The compositions in accordance with the invention are prepared from the natural rubber/carbon black masterbatch. Introduced into an internal mixer, the capacity of which is 3.3 l, filled to 70%, and the initial vessel temperature of which is around 60° C., are the masterbatch and the dihydrazide compound and then, after one to two minutes of kneading, the stearic acid, the antioxidant and the paraffin are introduced. The zinc oxide is introduced at 145° C. Thermomechanical working (non-productive phase) is then carried out in one stage (total duration of the kneading equal to around 5 min), until a maximum “dropping” temperature of around 165° C. is reached.

The aforementioned first step of thermomechanical working is thus carried out, it being specified that the mean speed of the blades during this first step is 40 rpm.

The mixture thus obtained is recovered and cooled and then, in an external mixer, the sulphur and the sulphenamide are added at 30° C., the combined mixture being further mixed for a time of 3 to 4 minutes (second aforementioned step of mechanical working).

The compositions thus obtained are subsequently calendered, either in the form of slabs (with a thickness ranging from 2 to 3 mm) or thin sheets of rubber, for the measurement of their physical or mechanical properties.

Each of the compositions tested has the following formulation (expressed in phr: parts per hundred parts of elastomer):

| Formulation | Control (TX) | Invention (MX) |
|---|---|---|
| NR (1) | 100 | — |
| NR (2) | — | 100 |
| Carbon black (3) | 57 | — |
| Carbon black (4) | — | 57 |
| Antioxidant (5) | 1 | 1 |
| Paraffin | 1 | 1 |
| Stearic acid | 1.5 | 1.5 |
| ZnO | 3 | 3 |
| Accelerator (6) | 1.1 | 1.1 |
| Sulphur | 1.1 | 1.1 |

(1) = Natural rubber TSR20
(2) = Natural rubber originating from the masterbatch prepared previously
(3) = carbon black N234
(4) = carbon black N234 originating from the masterbatch prepared previously
(5) = N-(1,3-dimethylbutyl)-N′-phenyl-p-phenylenediamine
(6) = N-cyclohexyl-2-benzothiazyl sulphenamide

The dihydrazide compound was added to compositions TX and MX in a proportion of 1 phr, according to the table below which summarizes the various compositions:

| Compositions | Elastomer or masterbatch | Dihydrazide |
|---|---|---|
| TA | TSR20 | |
| TB | TSR20 | Terephthalic |
| TC | TSR20 | Adipic |
| MA | NR/carbon black masterbatch | |
| MB | NR/carbon black masterbatch | Terephthalic |
| MC | NR/carbon black masterbatch | Adipic |

The results of the tests are reported in the table below:

| | Composition | | | | | |
|---|---|---|---|---|---|---|
| | TA | TB | TC | MA | MB | MC |
| Properties in the | | | | | | |
| uncrosslinked state | | | | | | |
| MS 1 + 4 at 100° C. | 54 | 56 | 67 | 40 | 45 | 52 |
| (“Mooney mixture”) | | | | | | |
| Properties in the crosslinked | | | | | | |
| state | | | | | | |
| Z value | 82 | 79 | 81 | 94 | 93 | 92 |
| MA100 at 23° C. | 2.3 | 2.3 | 2.4 | 2.1 | 2.2 | 2.3 |
| MA300/MA100 at 23° C. | 1.26 | 1.26 | 1.25 | 1.47 | 1.46 | 1.49 |
| Strain at break at 60° C. | 576 | 554 | 575 | 566 | 553 | 544 |
| Stress at break at 60° C. | 25.9 | 25.2 | 26.9 | 26.6 | 26.9 | 27.4 |
| (tan□□δ)□ max at 60° C. | 0.244 | 0.233 | 0.237 | 0.215 | 0.201 | 0.193 |

The comparison of compositions TA and MA makes it possible to observe a gain in dispersion, in reinforcement and in hysteresis of the masterbatch-based composition that displays a very good dispersion. This masterbatch-based composition MA displays an improvement in the hysteresis and reinforcing properties compared to composition TA.

Compositions TB and TC, compared to composition TA, displays an unexpected gain in hysteresis of the dihydrazide-based compositions.

Compositions MB and MC, in accordance with the invention, compared to composition MA, displays a gain in hysteresis of 7% to 11% while maintaining a same level of reinforcement. It is observed that the effect of the dihydrazide is retained, or even improved, which is surprising in view of the mechanism of action of the dihydrazides and the state of knowledge of those skilled in the art, since in the masterbatch-based compositions, the interface between the filler and the elastomer is already made and since this should be detrimental to the effect of the dihydrazide. Due to the reduced hysteresis which characterizes compositions MB and MC with respect to the dihydrazide-free composition MA, it will be noted that a tyre comprising one of these compositions according to the invention has an unexpected improvement in the self-heating and rolling resistance properties, while maintaining the wear resistance properties.

1. A reinforced rubber composition based at least (a) on an elastomeric matrix comprising natural rubber as the predominant diene elastomer, (b) on a reinforcing filler comprising carbon black in a weight fraction of more than 50% relative to the total weight of the filler, and (c) on a compound selected from:
the carbohydrazide of formula H₂N—NH—CO—NH—NH₂ and
the compounds corresponding to one of the following formulae I, II, III, IV, V and VI: 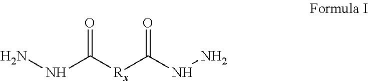
wherein:
R is a divalent hydrocarbon-based radical, which may comprise one or more heteroatoms such as O, N, S or Si, selected from substituted or unsubstituted aromatic radicals having from 6 to 20 carbon atoms, linear or branched, saturated or unsaturated aliphatic radicals having from 1 to 20 carbon atoms, a divalent hydantoin residue, and
x is equal to 0 or 1, 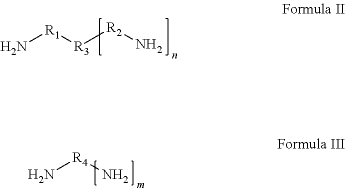
wherein:
R₁ and R₂, which are identical or different, are selected from the group consisting of alkylidenes having from 1 to 20 carbon atoms, cycloalkylidenes having from 5 to 24 carbon atoms, arylidenes having from 6 to 18 carbon atoms, aralkylidenes having from 7 to 25 carbon atoms and heterocycles, which are identical or different, having from 4 to 25 carbon atoms;
R₃ and R₄, which are identical or different, are selected from the group consisting of alkylidenes having from 1 to 20 carbon atoms, alkylidynes having from 1 to 20 carbon atoms, alkylylidynes having from 1 to 20 carbon atoms, cycloalkylidenes having from 5 to 24 carbon atoms, cycloalkylidynes having from 5 to 24 carbon atoms, cycloalkylylidynes having from 5 to 24 carbon atoms, arylidenes having from 6 to 18 carbon atoms, arylidynes having from 6 to 18 carbon atoms, arylylidynes having from 6 to 18 carbon atoms, aralkylidenes having from 7 to 25 carbon atoms, aralkylidynes having from 6 to 18 carbon atoms, aralkylylidynes having from 6 to 18 carbon atoms, and heterocycles, which are identical or different, having from 4 to 25 carbon atoms;
R₃ optionally comprises one or more identical or different heteroatom(s), selected from O, N, S and Si;
m is equal to 1, 2 or 3;
n is equal to 1, 2 or 3, 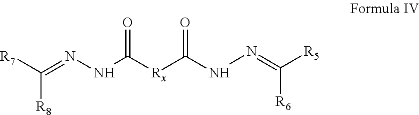
wherein:
R₅, R₆, R₇ and R₈, which are identical or different, are selected from alkyl groups having from 1 to 20 carbon atoms, cycloalkyl groups having from 5 to 24 carbon atoms, aryl groups having from 6 to 18 carbon atoms or aralkyl groups having from 7 to 25 carbon atoms;
R and x are as defined above for Formula I, 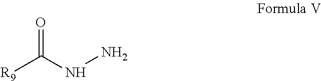
wherein:
R₉ is a polar group which is selected from at least one of alkylene groups, phenylene groups or heterocycles containing nitrogen or oxygen having at least one imino, nitrile, ammonium, imido, amide, hydrazo, azo, diazo, hydroxyl, carboxylic, epoxide, oxycarbonyl, tin or alkoxysilyl group, 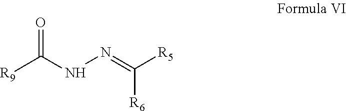
wherein:
R₅, R₆ and R₉ are as defined above for Formulae IV and V,
wherein the filler is dispersed in the elastomeric matrix of the composition with a Z value of greater than or equal to 85.

2. The reinforced rubber composition according to claim 1, wherein the reinforcing filler consists of 100% carbon black.

3. The reinforced rubber composition according to claim 1, wherein the reinforcing filler comprises a reinforcing inorganic filler and the compound (c) is selected from:
the carbohydrazide of formula H₂N—NH—CO—NH—NH₂ and
the compounds corresponding to one of the formulae I, II, III and V defined in claim 1.

4. The reinforced rubber composition according to claim 1, wherein the rubber composition is obtained from a masterbatch comprising at least natural rubber and carbon black, and having a dispersion of the carbon black in said masterbatch that has a Z value of greater than or equal to 90.

5. The reinforced rubber composition according to claim 4, wherein the carbon black is dispersed in at least natural rubber in order to form a masterbatch by liquid-phase compounding starting from a diene elastomer latex and an aqueous dispersion of carbon black.

6. The reinforced rubber composition according to claim 5, wherein the carbon black is dispersed in at least natural rubber by implementing the following process steps:
feeding a first fluid, which is a continuous flow of a diene elastomer latex to a mixing zone of a coagulation reactor defining an elongate coagulation zone extending between the mixing zone and an outlet,
feeding said mixing zone of the coagulation reactor with a second fluid, which is a continuous flow of a fluid comprising a filler comprising carbon black under pressure, in order to form a mixture with the elastomer latex by mixing the first fluid and the second fluid in the mixing zone in a sufficiently energetic manner to coagulate the elastomer latex with the filler before the outlet, said mixture flowing as a continuous flow to the outlet and said filler being capable of coagulating the elastomer latex to form a coagulum,
recovering, at the outlet of the reactor, the coagulum obtained above in the form of a continuous flow and drying it in order to recover the masterbatch.

7. The reinforced rubber composition according to claim 1, wherein the compound (c) is present in a proportion ranging from 0.1 to 7 phr.

8. The reinforced rubber composition according to claim 1, wherein the weight fraction of natural rubber in the elastomeric matrix has a value of at least 50% by weight and of at most 100% by weight of the total weight of the matrix.

9. The reinforced rubber composition according to claim 1, wherein the compound (c) is a dihydrazide of formula I selected from the group consisting of phthalic dihydrazide, isophthalic dihydrazide, terephthalic dihydrazide, succinic dihydrazide, adipic dihydrazide, azelaic dihydrazide, sebacic dihydride, oxalic dihydrazide and dodecanoic dihydrazide.

10. A process for preparing a reinforced rubber composition based at least (a) on an elastomeric matrix comprising natural rubber as the predominant diene elastomer, (b) on a reinforcing filler comprising carbon black in a weight fraction of more than 50% relative to the total weight of the filler, and (c) on a compound selected from:
the carbohydrazide of formula H₂N—NH—CO—NH—NH₂ and
the compounds corresponding to one of the following formulae I, II, III, IV, V and VI: 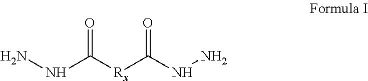
wherein:
R is a divalent hydrocarbon-based radical, which may comprise one or more heteroatoms such as O, N, S or Si, selected from substituted or unsubstituted aromatic radicals having from 6 to 20 carbon atoms, linear or branched, saturated or unsaturated aliphatic radicals having from 1 to 20 carbon atoms, a divalent hydantoin residue, and
x is equal to 0 or 1, 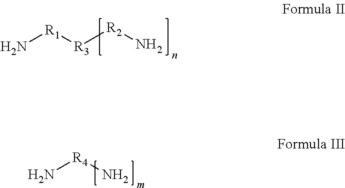
wherein:
R₁ and R₂, which are identical or different, are selected from the group consisting of alkylidenes having from 1 to 20 carbon atoms, cycloalkylidenes having from 5 to 24 carbon atoms, arylidenes having from 6 to 18 carbon atoms, aralkylidenes having from 7 to 25 carbon atoms and heterocycles, which are identical or different, having from 4 to 25 carbon atoms;
R₃ and R₄, which are identical or different, are selected from the group consisting of alkylidenes having from 1 to 20 carbon atoms, alkylidynes having from 1 to 20 carbon atoms, alkylylidynes having from 1 to 20 carbon atoms, cycloalkylidenes having from 5 to 24 carbon atoms, cycloalkylidynes having from 5 to 24 carbon atoms, cycloalkylylidynes having from 5 to 24 carbon atoms, arylidenes having from 6 to 18 carbon atoms, arylidynes having from 6 to 18 carbon atoms, arylylidynes having from 6 to 18 carbon atoms, aralkylidenes having from 7 to 25 carbon atoms, aralkylidynes having from 6 to 18 carbon atoms, aralkylylidynes having from 6 to 18 carbon atoms, and heterocycles, which are identical or different, having from 4 to 25 carbon atoms;
R₃ optionally comprises one or more identical or different heteroatom(s), selected from O, N, S and Si;
m is equal to 1, 2 or 3;
n is equal to 1, 2 or 3, 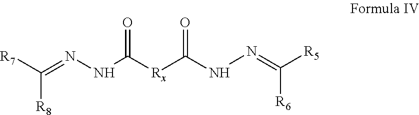
wherein:
R₅, R₆, R₇ and R₈, which are identical or different, are selected from alkyl groups having from 1 to 20 carbon atoms, cycloalkyl groups having from 5 to 24 carbon atoms, aryl groups having from 6 to 18 carbon atoms or aralkyl groups having from 7 to 25 carbon atoms;
R and x are as defined above for Formula I, 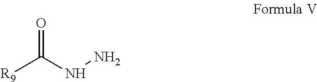
wherein:
R₉ is a polar group which is selected from at least one of alkylene groups, phenylene groups or heterocycles containing nitrogen or oxygen having at least one imino, nitrile, ammonium, imido, amide, hydrazo, azo, diazo, hydroxyl, carboxylic, epoxide, oxycarbonyl, tin or alkoxysilyl group, 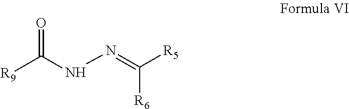
wherein:
R₅, R₆ and R₉ are as defined above for Formulae IV and V, comprising:
(i) manufacturing a masterbatch from at least natural rubber and carbon black by dispersion of the carbon black in at least the natural rubber with a dispersion Z value of greater than or equal to 90,
(ii) adding to the masterbatch obtained in (i) based on natural rubber and on carbon black, the compound (c), to form a second masterbatch;
(ii) carrying out, at a maximum temperature of between 130° C. and 200° C., a first step of thermomechanical working of the necessary base constituents of the rubber composition, with the exception of the crosslinking system, by intimately incorporating, by kneading, ingredients of the composition into the masterbatch obtained in (i), then
(iii) carrying out, at a temperature below said maximum temperature of said first step, preferably below 120° C., a second step of mechanical working during which said crosslinking system, and where appropriate adhesion promoter, are incorporated.

11. A process for preparing a reinforced rubber composition based at least (a) on an elastomeric matrix comprising natural rubber as the predominant diene elastomer, (b) on a reinforcing filler comprising carbon black in a weight fraction of more than 50% relative to the total weight of the filler, and (c) on a compound selected from:
the carbohydrazide of formula H₂N—NH—CO—NH—NH₂ and
the compounds corresponding to one of the following formulae I, II, III, IV, V and VI: 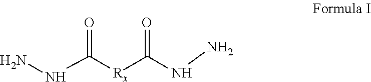
wherein:
R is a divalent hydrocarbon-based radical, which may comprise one or more heteroatoms such as O, N, S or Si, selected from substituted or unsubstituted aromatic radicals having from 6 to 20 carbon atoms, linear or branched, saturated or unsaturated aliphatic radicals having from 1 to 20 carbon atoms, a divalent hydantoin residue, and
x is equal to 0 or 1, 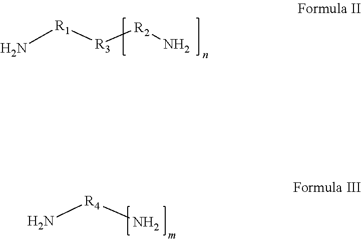
wherein:
R₁ and R₂, which are identical or different, are selected from the group consisting of alkylidenes having from 1 to 20 carbon atoms, cycloalkylidenes having from 5 to 24 carbon atoms, arylidenes having from 6 to 18 carbon atoms, aralkylidenes having from 7 to 25 carbon atoms and heterocycles, which are identical or different, having from 4 to 25 carbon atoms;
R₃ and R₄, which are identical or different, are selected from the group consisting of alkylidenes having from 1 to 20 carbon atoms, alkylidynes having from 1 to 20 carbon atoms, alkylylidynes having from 1 to 20 carbon atoms, cycloalkylidenes having from 5 to 24 carbon atoms, cycloalkylidynes having from 5 to 24 carbon atoms, cycloalkylylidynes having from 5 to 24 carbon atoms, arylidenes having from 6 to 18 carbon atoms, arylidynes having from 6 to 18 carbon atoms, arylylidynes having from 6 to 18 carbon atoms, aralkylidenes having from 7 to 25 carbon atoms, aralkylidynes having from 6 to 18 carbon atoms, aralkylylidynes having from 6 to 18 carbon atoms, and heterocycles, which are identical or different, having from 4 to 25 carbon atoms;
R₃ optionally comprises one or more identical or different heteroatom(s), selected from O, N, S and Si;
m is equal to 1, 2 or 3;
n is equal to 1, 2 or 3, 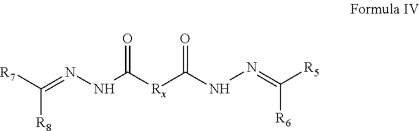
wherein:
R₅, R₆, R₇ and R₅, which are identical or different, are selected from alkyl groups having from 1 to 20 carbon atoms, cycloalkyl groups having from 5 to 24 carbon atoms, aryl groups having from 6 to 18 carbon atoms or aralkyl groups having from 7 to 25 carbon atoms;
R and x are as defined above for Formula I, 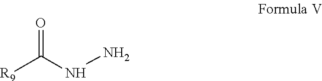
wherein:
R₉ is a polar group which is selected from at least one of alkylene groups, phenylene groups or heterocycles containing nitrogen or oxygen having at least one imino, nitrile, ammonium, imido, amide, hydrazo, azo, diazo, hydroxyl, carboxylic, epoxide, oxycarbonyl, tin or alkoxysilyl group, 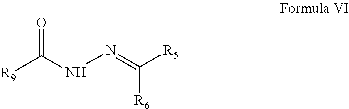
wherein:
R₅, R₆ and R₉ are as defined above for Formulae IV and V, comprising:
(i) manufacturing a masterbatch from at least natural rubber and carbon black by liquid-phase compounding starting from at least a natural rubber latex and an aqueous dispersion of carbon black;
(ii) carrying out, at a maximum temperature of between 130° C. and 200° C., a first step of thermomechanical working of the necessary base constituents of the rubber composition, with the exception of the crosslinking system, by intimately incorporating, by kneading, ingredients of the composition into the masterbatch obtained in (i), then
(iii) carrying out, at a temperature below said maximum temperature of said first step, preferably below 120° C., a second step of mechanical working during which said crosslinking system, and where appropriate adhesion promoter, are incorporated.

12. The process according to claim 10, wherein in step (i), the carbon black is dispersed in at least carbon natural rubber by liquid-phase compounding starting from at least a natural rubber latex and an aqueous dispersion of carbon black.

13. The process according to claim 11, wherein in step (i), the liquid-phase compounding starting from at least a natural rubber latex and an aqueous dispersion of carbon black comprises:
feeding, a first fluid, which is a continuous flow of a diene elastomer latex, to a mixing zone of a coagulation reactor defining an elongate coagulation zone extending between the mixing zone and an outlet,
feeding said mixing zone of the coagulation reactor with a second fluid, which is a continuous flow of a fluid comprising a filler comprising carbon black under pressure, in order to form a mixture with the elastomer latex by mixing the first fluid and the second fluid in the mixing zone in a sufficiently energetic manner to coagulate the elastomer latex with the filler before the outlet, said mixture flowing as a continuous flow to the outlet zone and said filler being capable of coagulating the elastomer latex to form a coagulum,
recovering, at the outlet of the reactor, the coagulum obtained above in the form of a continuous flow and drying it in order to recover the masterbatch.

14. The process according to claim 10, further comprising, at the end of step (i) and before step (ii), an intermediate step of adding to the masterbatch based on natural rubber and on carbon black obtained in (i), of the compound (c) in order to form a second masterbatch.

15. The process according to claim 10, wherein the compound (c) is incorporated into the masterbatch obtained in (i) during step (ii).

16. The process according to claim 10, wherein the compound (c) is incorporated with the crosslinking system during step (iii).

17. A reinforced rubber composition obtained according to the process of claim 10.

18. A masterbatch including at least natural rubber as the predominant diene elastomer, carbon black and a compound selected from:
the carbohydrazide of formula H₂N—NH—CO—NH—NH₂ and
the compounds corresponding to one of the following formulae I, II, III, IV, V and VI: 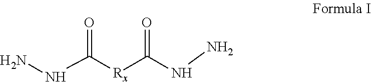
wherein:
R is a divalent hydrocarbon-based radical, which may comprise one or more heteroatoms such as O, N, S or Si, selected from substituted or unsubstituted aromatic radicals having from 6 to 20 carbon atoms, linear or branched, saturated or unsaturated aliphatic radicals having from 1 to 20 carbon atoms, a divalent hydantoin residue, and
x is equal to 0 or 1, 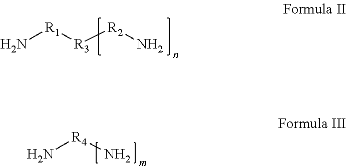
wherein:
R₁ and R₂, which are identical or different, are selected from the group consisting of alkylidenes having from 1 to 20 carbon atoms, cycloalkylidenes having from 5 to 24 carbon atoms, arylidenes having from 6 to 18 carbon atoms, aralkylidenes having from 7 to 25 carbon atoms and heterocycles, which are identical or different, having from 4 to 25 carbon atoms;
R₃ and R₄, which are identical or different, are selected from the group consisting of alkylidenes having from 1 to 20 carbon atoms, alkylidynes having from 1 to 20 carbon atoms, alkylylidynes having from 1 to 20 carbon atoms, cycloalkylidenes having from 5 to 24 carbon atoms, cycloalkylidynes having from 5 to 24 carbon atoms, cycloalkylylidynes having from 5 to 24 carbon atoms, arylidenes having from 6 to 18 carbon atoms, arylidynes having from 6 to 18 carbon atoms, arylylidynes having from 6 to 18 carbon atoms, aralkylidenes having from 7 to 25 carbon atoms, aralkylidynes having from 6 to 18 carbon atoms, aralkylylidynes having from 6 to 18 carbon atoms, and heterocycles, which are identical or different, having from 4 to 25 carbon atoms;
R₃ optionally comprises one or more identical or different heteroatom(s), selected from O, N, S and Si;
m is equal to 1, 2 or 3;
n is equal to 1, 2 or 3, 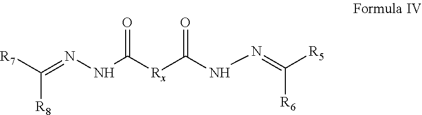
wherein:
R₅, R₆, R₇ and R₈, which are identical or different, are selected from alkyl groups having from 1 to 20 carbon atoms, cycloalkyl groups having from 5 to 24 carbon atoms, aryl groups having from 6 to 18 carbon atoms or aralkyl groups having from 7 to 25 carbon atoms;
R and x are as defined above for Formula I, 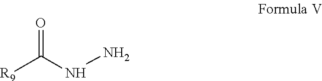
wherein:
R₉ is a polar group which is selected from at least one of alkylene groups, phenylene groups or heterocycles containing nitrogen or oxygen having at least one imino, nitrile, ammonium, imido, amide, hydrazo, azo, diazo, hydroxyl, carboxylic, epoxide, oxycarbonyl, tin or alkoxysilyl group, 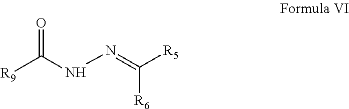
wherein:
R₅, R₆ and R₉ are as defined above for Formulae IV and V,
wherein the carbon black is dispersed in the elastomeric matrix of the masterbatch with a dispersion Z value of greater than or equal to 90.

19. A process for preparing a masterbatch based at least on natural rubber as the predominant diene elastomer, on carbon black and on a compound selected from:
the carbohydrazide of formula H₂N—NH—CO—NH—NH₂ and
the compounds corresponding to one of the following formulae I, II, III, IV, V and VI: 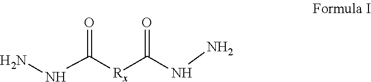
wherein:
R is a divalent hydrocarbon-based radical, which may comprise one or more heteroatoms such as O, N, S or Si, selected from substituted or unsubstituted aromatic radicals having from 6 to 20 carbon atoms, linear or branched, saturated or unsaturated aliphatic radicals having from 1 to 20 carbon atoms, a divalent hydantoin residue, and
x is equal to 0 or 1, 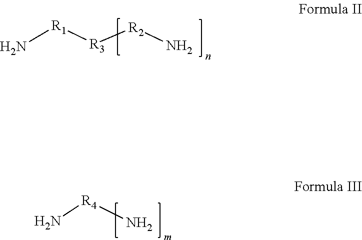
wherein:
R₁ and R₂, which are identical or different, are selected from the group consisting of alkylidenes having from 1 to 20 carbon atoms, cycloalkylidenes having from 5 to 24 carbon atoms, arylidenes having from 6 to 18 carbon atoms, aralkylidenes having from 7 to 25 carbon atoms and heterocycles, which are identical or different, having from 4 to 25 carbon atoms;
R₃ and R₄, which are identical or different, are selected from the group consisting of alkylidenes having from 1 to 20 carbon atoms, alkylidynes having from 1 to 20 carbon atoms, alkylylidynes having from 1 to 20 carbon atoms, cycloalkylidenes having from 5 to 24 carbon atoms, cycloalkylidynes having from 5 to 24 carbon atoms, cycloalkylylidynes having from 5 to 24 carbon atoms, arylidenes having from 6 to 18 carbon atoms, arylidynes having from 6 to 18 carbon atoms, arylylidynes having from 6 to 18 carbon atoms, aralkylidenes having from 7 to 25 carbon atoms, aralkylidynes having from 6 to 18 carbon atoms, aralkylylidynes having from 6 to 18 carbon atoms, and heterocycles, which are identical or different, having from 4 to 25 carbon atoms;
R₃ optionally comprises one or more identical or different heteroatom(s), selected from O, N, S and Si;
m is equal to 1, 2 or 3;
n is equal to 1, 2 or 3, 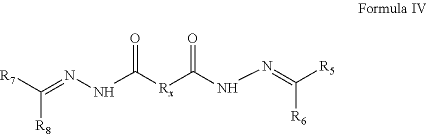
wherein:
R₅, R₆, R₇ and R₈, which are identical or different, are selected from alkyl groups having from 1 to 20 carbon atoms, cycloalkyl groups having from 5 to 24 carbon atoms, aryl groups having from 6 to 18 carbon atoms or aralkyl groups having from 7 to 25 carbon atoms;
R and x are as defined above for Formula I, 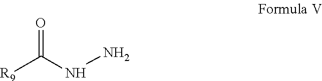
wherein:
R₉ is a polar group which is selected from at least one of alkylene groups, phenylene groups or heterocycles containing nitrogen or oxygen having at least one imino, nitrile, ammonium, imido, amide, hydrazo, azo, diazo, hydroxyl, carboxylic, epoxide, oxycarbonyl, tin or alkoxysilyl group, 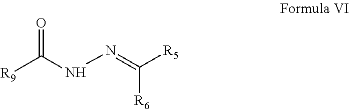
wherein:
R₅, R₆ and R₉ are as defined above for Formulae IV and V,
wherein the masterbatch is obtained by liquid-phase compounding starting from at least a natural rubber latex and an aqueous dispersion of carbon black by:
feeding, with a first fluid that is a continuous flow of a diene elastomer latex, a mixing zone of a coagulation reactor defining an elongate coagulation zone extending between the mixing zone and an outlet,
feeding said mixing zone of the coagulation reactor with a second fluid that is a continuous flow of a fluid comprising a filler under pressure in order to form a mixture with the elastomer latex by mixing the first fluid and the second fluid in the mixing zone in a sufficiently energetic manner to coagulate the elastomer latex with the filler before the outlet, said mixture flowing as a continuous flow to the outlet zone and said filler being capable of coagulating the elastomer latex to form a coagulum,
recovering, at the outlet of the reactor, the coagulum obtained above in the form of a continuous flow and drying it in order to recover the masterbatch,
adding to the first masterbatch the compound selected from the carbohydrazide or the compounds corresponding to one of the formulae I, II, III, IV, V and VI, in order to form a second masterbatch.

20. A masterbatch obtained by the process according to claim 19.

21. A rubber composition obtained from a masterbatch according to claim 18.

22. A finished or semi-finished rubber product, comprising a rubber composition according to claim 1.

23. A tire comprising a finished or semi-finished product according to claim 22.

24. The reinforced rubber composition according to claim 7, wherein the compound (c) is present in a proportion ranging from 0.1 to 1 phr.
